(19) United States
(12) Patent Application Publication
(10) Pub. No.: US 2026/0010000 A1
(43) Pub. Date: Jan. 8, 2026

(54) Window Type Beam Sampler With Mitigated Ghosting Effect

(71) Applicant: Oren Aharon, Haifa (IL)

(72) Inventor: Oren Aharon, Haifa (IL)

(21) Appl. No.: 18/762,764

(22) Filed: Jul. 3, 2024

(51) Int. Cl. G02B 27/00; G02B 1/11; G02B 5/00; G02B 27/14; H01S 3/00

(52) U.S. Cl. CPC G02B 27/0018; G02B 1/11; G02B 5/003; G02B 27/144; H01S 3/0014

(57) ABSTRACT

An optical glass beam sampler is a device used to extract a small portion of a laser beam for purposes such as measurement, monitoring, or analysis. It typically consists of optical glass with specific coatings and dimensions designed to reflect or transmit a small percentage of the incident laser beam while allowing the majority of the beam to continue on its path unaffected. Ghosting effects occur when secondary reflections or beams are created due to reflections from the second surface of a typical window-type beam sampler. This invention aims to prevent ghosting in applications where a small fraction of the beam is split without significantly altering its characteristics. The technology is based on optical slit designs that prevent back reflection, thus eliminating the ghosting effect. By eliminating ghosting, the performance of optical glass beam samplers is greatly enhanced.

### BACKGROUND OF THE INVENTION

### 1. Field of Invention

The field of invention relates to window-like optical beam samplers, involving devices and methods for sampling a portion of a laser beam without significantly altering its main path or characteristics. These samplers are critical for monitoring and analyzing laser beams in various applications, such as scientific research, industrial processing, and medical diagnostics. The primary function is to extract a small portion of a laser beam for measurement and analysis while minimizing ghosting from surfaces not directly related to the sampling surface. The design ensures minimal disruption to the main beam's path and characteristics, maintaining the integrity of the beam for its intended use.

### 2. Description of the Related Art

Window-like optical beam samplers are designed to sample a portion of a laser beam without significantly disrupting the main beam path. Related technologies include:

Beam Splitters: Devices that divide a beam into multiple parts, commonly used in optical systems to direct part of the beam to diagnostic instruments.

Optical Coatings: Anti-reflective and partial reflective coatings that control light reflection and transmission, essential for efficient beam samplers.

Attenuating Optical Elements: Neutral density filters that reduce the sampled beam's intensity to protect sensors in high-power laser applications.

Rotating Optical Samplers: Devices using rotating mechanisms to sample beams at different points, providing dynamic beam profile analysis.

Prisms and Mirrors: Used in beam sampling setups to direct portions of the beam to specific locations for analysis. These technologies ensure accurate and reliable beam sampling for applications in scientific research, industrial processing, and medical diagnostics.

### SUMMARY

When laser radiation encounters different media with different diffraction indices, Snell's law applies. The refractive index measures how much light slows down and bends when entering a medium compared to its speed in a vacuum. Different materials have different refractive indices, affecting light bending when passing through them. The angles of incidence and refraction are measured relative to the normal (perpendicular) to the interface between the two media. Snell's law, fundamental in optics, is given by:

n₁ sin θ₁=n₂ sin θ₂
where:
n1 and n2 are the refractive indices of the first and second mediums, respectively.
θ1 is the angle of incidence.
θ2 is the angle of refraction.

A typical window-type beam sampler reflects a portion of the incoming beam from its front surface and generates a ghost beam image from its back surface. This ghost image interferes with the primary reflected image, disrupting its quality. This innovation aims to eliminate this ghost image by:

Design Based on Snell's Law: Utilizing precise calculations to optimize the angles and refractive indices involved.

Innovative Slots: Introducing carefully designed slots into the window beam sampler to prevent back reflections, ensuring a clear and accurate sampled beam.

This design enhances the performance of window-type beam samplers by mitigating the ghosting effect, providing clearer and more reliable measurements.

### BRIEF DESCRIPTION OF THE DRAWINGS

Further advantages of the invention will emerge from the following descriptions and drawings, provided as non-limiting examples, in which:

FIG. 1 is a side view of a window beam sampler, describing the proposed sampler and its ray tracing.

### DETAILED DESCRIPTION OF THE DRAWINGS

In current technology, performing beam sampling using a window-type reflecting beam sampler involves intricate steps, including setup, angle adjustment, positioning, and calibration. The main obstacle, besides the setup, is the ghosting reflected from the second window surface. Ghosting refers to unwanted reflections that can interfere with the primary measurement of beam sampling and is very complicated to remove with standard technologies such as anti-reflective coating, optimization of angle incidence, optical isolation, and others. This invention offers an innovative method of removing ghosting and back reflection by the initial design of the beam samplers. The main idea is to create buffers into the beam sampler that block unwanted secondary reflections from the back surface. By implementing this technology, ghosting is reduced, ensuring accurate and reliable beam profiling using the technology of window-type reflecting samplers.

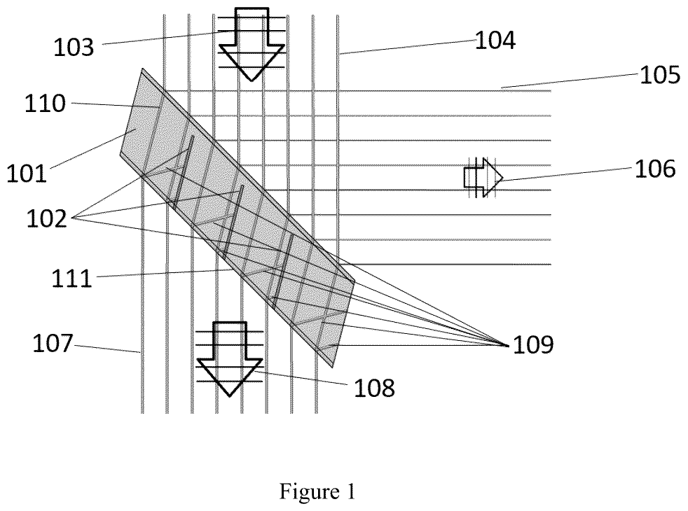

FIG. 1 illustrates an incoming main beam, represented by an arrow and labeled as 103. The rays constituting the incoming laser beam are labeled as 104. The first surface reflects a portion of this main beam, labeled as 106, with the ray tracing of 106 denoted as 105. The beam sampler itself is labeled as 101. On the rear side of the beam sampler 101, there is a set of slit buffers or etched lamellas inside the glass, labeled as 102. These lamellas are designed to be parallel to the refracted beam penetrating the glass surfaces, denoted as 110. The diffracted beam adheres to Snell's law, with its diffraction determined by the refractive index of the specific glass. Since the lamellas are parallel to the penetrating laser beam, they minimally affect the total power passing through the glass. The beam passing through the glass, labeled as 108, exits parallel to beam 103, with the ray directions of the exiting beam denoted as 107. This occurs when the beam sampler has parallel surfaces. The back surface of the sampler, labeled as 111, partially reflects the refracted beams before they exit the sampler. This partial reflection, labeled as 109, is absorbed by the lamellas. Without the lamellas, this reflection would exit on the upper side of the beam sampler, causing ghosting. By absorbing this radiation, the lamellas prevent ghosting from exiting the first surface, thus ensuring the integrity of the beam sampler.

1. An optical beam sampler comprising:
a piece of optical glass designed to reflect a portion of an incident laser beam from its front surface; and
an innovative set of slots introduced into the optical glass to prevent back reflections and eliminate ghosting effects, wherein the design of the slots is based on Snell's law to optimize the angles and refractive indices involved.

2. The optical beam sampler of claim 1, wherein the optical glass includes anti-reflective coatings on both surfaces to minimize unwanted reflections and enhance beam sampling accuracy.

3. The optical beam sampler of claim 1, wherein the set of slots are precisely positioned and dimensioned to disrupt secondary reflections from the back surface, ensuring the sampled beam is free from ghost images.

4. The optical beam sampler of claim 1, wherein the sampler is configured to maintain the integrity of the main beam path while extracting a small portion of the beam for measurement and analysis.

5. The optical beam sampler of claim 1, further comprising:
a mechanism for adjusting the orientation of the optical glass to optimize the angle of incidence and reduce ghosting effects based on specific application requirements.

6. The optical beam sampler of claim 1, wherein the slots are filled with a material having a refractive index matched to that of the optical glass to further reduce back reflections and enhance performance.

7. The optical beam sampler of claim 1, wherein the sampler is used in high-power laser applications, providing accurate and reliable beam sampling without compromising the main beam's characteristics.

8. The optical beam sampler of claim 1, wherein the optical glass is designed with specific dimensions to achieve optimal performance in terms of beam reflection and transmission, while minimizing ghosting effects.

9. The optical beam sampler of claim 1, wherein the sampler is integrated into a system for real-time laser beam monitoring and analysis, ensuring high precision and reliability.

10. The optical beam sampler of claim 1, wherein the design of the slots and the use of Snell's law principles enable the sampler to be effective across a wide range of wavelengths and laser types, making it versatile for various applications.
